(19) United States
(12) Patent Application Publication
(10) Pub. No.: US 2026/0267776 A1
(43) Pub. Date: Sep. 10, 2026

(54) IDENTIFYING COMPUTER PROGRAM FUNCTIONALITY AND REDUCING TEST DUPLICATION

(71) Applicant: INTERNATIONAL BUSINESS MACHINES CORPORATION, Armonk, NY (US)

(72) Inventors: Sarika Sinha, Sarjapur (IN); Siddharth K. Saraya, Raniganj (IN)

(21) Appl. No.: 19/069,904

(22) Filed: Mar. 4, 2025

(51) Int. Cl. G06F 11/3668

(52) U.S. Cl. CPC G06F 11/3672

(57) ABSTRACT

Systems, methods, and computer program products for testing a computer program are disclosed. A method may comprise reading a first natural language description, the first natural language description describing a plurality of scenarios for testing a computer program; identifying a plurality of unit clauses in the first natural language description, wherein each unit clause comprises a low-order verb; generating a unit test case for each of the plurality of unit clauses; testing the computer program according to the unit test cases; identifying a plurality of integration clauses in the first natural language description, wherein each integration clause is modified by at least one adverb; generating an integration test case for each of the plurality of integration clauses; and testing the computer program according to the integration test cases.

### BACKGROUND

Embodiments of the present disclosure relate to testing computer programs, and more specifically, to identifying lowest order functionality and reducing test duplication across layers of computer program testing.

### BRIEF SUMMARY

According to embodiments of the present disclosure, systems, methods of, and computer program products for testing a computer program are disclosed. In various embodiments of the present disclosure a first natural language description is read. The first natural language description may describe a plurality of scenarios for testing the computer program. A plurality of unit clauses in the first natural language description is identified. Each unit clause may comprise a low-order verb. A plurality of unit test cases may be generated such that a unit test case is generated for each of the plurality of unit clauses. The computer program is tested according to the plurality of unit test cases. A plurality of integration clauses is identified in the first natural language description. Each integration clause may be modified by at least one adverb. A plurality of integration test cases may be generated such that an integration test case is generated for each of the plurality of integration clauses. The computer program may be tested according to the plurality of integration test cases.

### BRIEF DESCRIPTION OF THE DRAWINGS

FIG. 1 is a flow diagram depicting an exemplary method for testing a computer program, in accordance with one or more embodiments of this disclosure.

FIG. 2 is a flow diagram depicting an exemplary method for testing a computer program, in accordance with one or more embodiments of this disclosure.

FIG. 3 depicts a computing node according to one or more embodiments of the present disclosure.

### DETAILED DESCRIPTION

In software development, testing is conducted at various levels, including Unit, Functional, and Integration testing. These tests are typically performed in isolation, each focusing on specific aspects such as requirements, code, or design. While there are numerous tools available for creating and executing test cases, a significant gap exists in how these disparate test phases relate to one another and how the same set of data can be utilized across different testing stages. This disconnection can lead to inefficiencies, increased costs, and potential inconsistencies in the testing process.

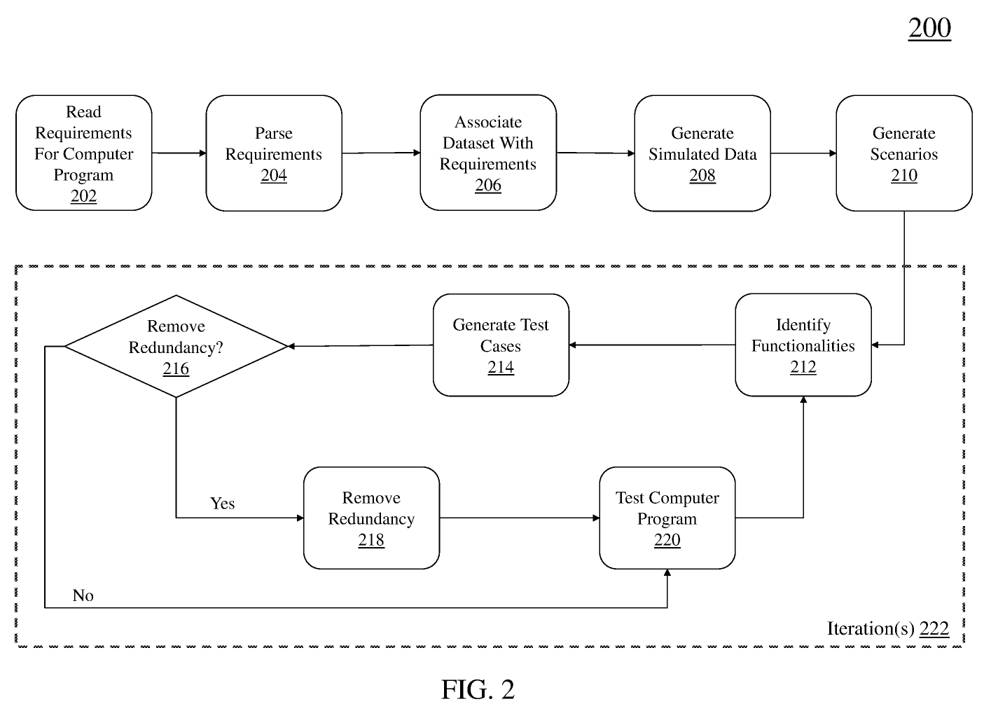

Referring now to FIG. 2 a flowchart illustrating an exemplary method 200 for testing a computer program is depicted. The operations of method 200 presented below are intended to be illustrative. In some implementations, method 200 is accomplished with one or more additional operations not described and/or without one or more of the operations discussed. The operations of method 200 may be performed in another order. Additionally, the order in which the operations of method 200 are illustrated in FIG. 2 and described below is not intended to be limiting.

In some implementations, method 200 is implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 200.

Operation 202 may comprise reading requirements for a computer program. In some implementations, operation 202 comprises reading user input characterizing a set of requirements for the computer program. The user input may have been provided via a computing platform. In some implementations, the computing platform is a client computing platform. The requirements may be stored on a local server, a remote server, non-transitory electronic storage, and/or on another modality. The requirements may be in the form of natural language and/or anotherform. For example, the requirements may comprise one or more of a user story, a use case, and/or other requirements. In some implementations, operation 202 comprises identifying correspondence between individual requirements and individual elements of the low-level design of the computer program. In some implementations, operation 202 comprises identifying correspondence between individual requirements and individual elements of the high-level design of the computer program. For example, a requirement may correspond to a high-level design element and/or a low-level design element by virtue of a portion of the computer program being intended to satisfy the requirement.

Operation 204 may comprise parsing the requirements. Operation 204 may comprise reading each requirement. Any associated high-level design elements and/or low-level design requirements may be read with each requirement. Operation 206 may comprise associating a portion of a dataset with each requirement. For example, the dataset may have been obtained from one or more sources. The associated portion of the dataset for a requirement may comprise data suitable for testing whether the computer program satisfies the requirement.

Operation 208 may comprise generating simulated data. Generating the simulated data may comprise providing the dataset as input to a generative machine learning model. For example, the generative machine learning model is a generative adversarial network (GAN), an autoregressive model, a diffusion model, a variational autoencoder (VAE), a transformer, a flow-based model, and/or another type of machine learning model. Generating the simulated data may comprise reading simulated data generated by the generative machine learning model. In some implementations, operation 208 comprises including the simulated data in the dataset.

Operation 210 may comprise generating scenarios. The scenarios may be in the form of natural language, language embeddings, and/or another format. Each scenario may represent a series of one or more events regarding the use of the computer program. The scenarios may comprise one or more scenarios lacking by the requirements and/or the design. The scenarios may be suitable for testing the computer program. In some implementations, generating the scenarios comprises providing the requirements, the dataset, the high-level design of the computer program, the low-level design of the computer program, and/or other information as input to a language model. The language model may comprise a generative adversarial network (GAN), an autoregressive model, a diffusion model, a variational autoencoder (VAE), a transformer, a flow-based model, and/or another type of machine learning model. For example, the language model is a transformer network. For example, generating the scenarios comprises deriving long-range dependency between words, tokens, phrases, and/or other units of language of the input to the language model. Generating the scenarios may comprise reading one or more scenario descriptions generated by the language model based on the input thereto. Each scenario description may describe a scenario.

One or more of operation 212, operation 214, determination 216, operation 218, and/or operation 220 may be performed more than once. The computer program may be tested at a plurality of levels. The levels may comprise unit, integration, system, smoke, and/or other levels for software testing. Method 200 may comprise performing one or more iterations 222. Performing each iteration 222 may comprise performing one or more of operation 212, operation 214, determination 216, operation 218, and operation 220. For example, at least operation 212, operation 214, determination 216, and operation 220 may be performed for each level of testing the computer program. For example, a first iteration of iteration(s) 222 is performed to test the computer program at a unit testing level. For example, a second iteration of iteration(s) 222 is performed to test the computer program at an integration testing level. For example, a third iteration of iteration(s) 222 is performed to test the computer program at a system testing level.

Operation 212 may comprise identifying functionalities. Each functionality may be an intended functionality for the computer program. Each functionality may be related to, identified in, and/or used in one or more of the scenarios. Identifying the functionalities may comprise identifying one or more smaller scenarios for each scenario. The smaller scenarios for a scenario may be identified based on the description for that scenario. For example, identifying one or more smaller scenarios comprises dividing a scenario description into one or more segments. Each segment may have an independent existence. In some implementations, each segment comprises a verb, an adverb, and/or another part of speech. A segment having an independent existence may be a portion of the scenario description having understandable meaning apart from the rest of the scenario description. For example, different levels of functionalities may be identified based on the current iteration of iteration(s) 222. In some implementations, identifying the functionalities comprises identifying a level of functionalities to identify based on the current iteration.

Identifying the functionalities may comprise identifying verb and adverb pairs in each scenario description. The adverb may be an adverbial clause, an adverbial phrase, and/or an adverb. Each verb and adverb pair may comprise one or more of at least one verb, at least one adverb modifying the at least one verb, and/or other parts of speech. The at least one verb may have a qualifying meaning. A verb having qualifying meaning is used to modify, limit, or specify the action or state it describes. Qualifying verbs add nuance, detail, or context to the main verb, providing additional information about how, when, where, or to what extent the action or state occurs. Qualifying verbs may convey more precise and detailed meanings in sentences compared to low-order verbs by indicating the likelihood, obligation, permission, manner, time, place, degree, or condition associated with the action. Exemplary qualifying verbs comprise modal verbs (e.g., can, could, may, might, must, shall, should, will, would), auxiliary verbs (e.g., be, have, do), and adverbial verbs (e.g., seem, appear, become).

In some implementations, identifying the functionalities comprises identifying a verb and adverb pair nested within another verb and adverb pair. For example, nested verb and adverb pairs are identified iteratively. For example, said iterative identification may be performed a number of times in accordance with the current iteration of iteration(s) 222. For example, the iterative identification continues until each verb and adverb pair comprises one or more of one verb, an adverb, and/or other parts of speech. For example, the one verb may be a low-order verb. A low-order verb is a verb that describes basic, fundamental actions or states of being. Exemplary low-order verbs comprise "to be," "to have," "to do," "to go," "to come," "to see," "to get," "to make," "to take," and "to give."

In some implementations, identifying the functionalities comprises identifying a plurality of unit clauses in the scenario descriptions. For example, the unit clauses are identified during the first iteration of iteration(s) 222. Each unit clause may comprise a low-order verb. In some implementations, the plurality of unit clauses may lack any adverbs. For example, a unit clause lacking any adverbs may indicate any verbs in the unit clause are not modified by any adverbs.

In some implementations, identifying the functionalities comprises identifying a plurality of integration clauses in the first natural language description. For example, the integration clauses are identified during the second iteration of iteration(s) 222. Each integration clause may be modified by at least one adverb. For example, the integration clause comprises a verb and adverb pair.

Operation 214 may comprise generating a set of test cases. For example, each test case of the set of test cases may be a unit test case, an integration test case, a system test case, and/or another type of test case. The set of test cases may be identified based on the identified functionalities. A set of test cases may be generated at each performance of operation 214. For example, during the first iteration, a first set of test cases may be generated at operation 214. In some implementations, the type and/or level of the test cases generated is based on the current iteration. For example, during the first iteration, generating the set of test cases comprises generating a set of unit test cases. For example, during the second iteration, generating the set of test cases comprises generating a set of integration test cases. For example, test cases for higher level functionalities are generated during later iterations 222.

Determination 216 may comprise determining whether to remove redundancy between the set of test cases generated during the current iteration and any previously generated sets of test cases. Determination 216 may comprise identifying features covered by the set of test cases. Determination 216 may comprise identifying features covered by the previously generated sets of test cases. Determination 216 may comprise determining whether any features covered by the set of test cases was also covered by the previously generated sets of test cases. Determination 216 may comprise determining whether the computer program has been modified between the current iteration and a previous iteration of iteration(s) 222. For example, one or more previously performed test cases may be repeated responsive to determining the computer program has been modified. Determination 216 may comprise validating the dataset. For example, the dataset is determined to be invalid due to one or more values being changed, a functionality expectation changing, and/or another reason. In some implementations, determination 216 may comprise determining to not remove overlap responsive to said validation indicating the dataset is invalid. In some implementations, responsive to determining the dataset is invalid, the computer program is tested according to a set of one or more previously tested test cases. For example, the computer program is tested according to unit test cases responsive to during the dataset is invalid.

Operation 218 may comprise removing redundancy from the set of test cases. Operation 218 may be performed responsive to determining to remove redundancy at determination 216. Removing the redundancy may comprise identifying a first set of program branches covered by the set of test cases. Removing the redundancy may comprise identifying a second set of paths covered by the previously generated set(s) of test cases. Removing the redundancy may comprise selected the program branches in the first set and the second set. Removing the redundancy may comprise removing the selected program branches from the test cases of the set of test cases. In some implementations, each test case comprises at least one step. Each step may be associated with at least one path covered by that test. Removing the selected program branches from the set of test cases may comprise removing each step associated with that path for each path of the selected program branches.

Operation 220 may comprise testing the computer program. For example, the computer program may be tested according to the set of test cases generated during the current iteration. Operation 220 may be performed responsive to determining not to remove redundancy at determination 216. Operation 220 may be performed responsive to removing redundancy at operation 218. Testing the computer program may comprise identifying data from the dataset for each test case. The identified data may comprise input data and target output data. Testing the computer program may comprise providing the input data as input to the computer program. Testing the computer program may comprise providing one or more values generated by the computer program during at least one previous iteration as input to the computer program. Testing the computer program may comprise reading one or more values generated by the computer program based on the input thereto. Testing the computer program may comprise comparing the one or more generated values to the target output data.

For example, operation 220 comprises testing the computer program according to a set of unit test cases during the first iteration. Operation 220 may comprise selecting one or more input values from the dataset. Operation 220 may comprise providing the one or more input values to the computer program in accordance with the set of unit test cases. Operation 220 may comprise reading a first output generated by the computer program based on the input thereto. Operation 220 may comprise recording the first output and the one or more input values.

For example, operation 220 comprises testing the computer program according to a set of integration test cases during the second iteration. Operation 220 may comprise providing the one or more input values as input to the computer program in accordance with the plurality of integration test cases. Operation 220 may comprise reading a second output generated by the computer program based on the input thereto.

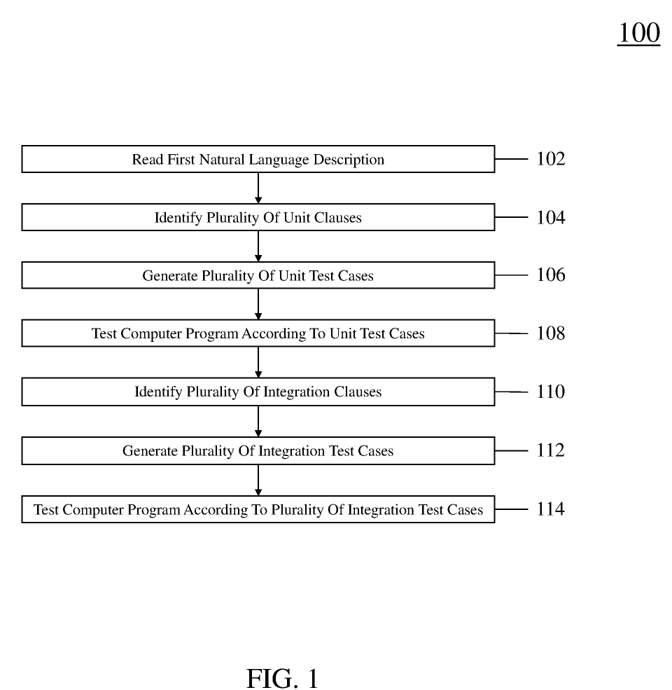

Referring now to FIG. 1 a flowchart illustrating an exemplary method 100 for testing a computer program is depicted. The operations of method 100 presented below are intended to be illustrative. In some implementations, method 100 is accomplished with one or more additional operations not described and/or without one or more of the operations discussed. The operations of method 100 may be performed in another order. Additionally, the order in which the operations of method 100 are illustrated in FIG. 1 and described below is not intended to be limiting.

In some implementations, method 100 is implemented in one or more processing devices (e.g., a digital processor, an analog processor, a digital circuit designed to process information, a state machine, and/or other mechanisms for electronically processing information). The one or more processing devices may include one or more devices configured through hardware, firmware, and/or software to be specifically designed for execution of one or more of the operations of method 100.

Operation 102 may comprise reading a first natural language description. The first natural language description describing a plurality of scenarios for testing a computer program. Operation 104 may comprise identifying a plurality of unit clauses in the first natural language description. Each unit clause may comprise a low-order verb. Operation 106 may comprise generating a plurality of unit test cases. The plurality of unit test case may be generated such that a unit test case is generated for each of the plurality of unit clauses. Operation 108 may comprise testing the computer program according to the plurality of unit test cases.

Operation 110 may comprise identifying a plurality of integration clauses in the first natural language description. Each integration clause may be modified by at least one adverb. Operation 112 may comprise generating a plurality of integration test cases. The plurality of integration test case may be generated such that an integration test case is generated for each of the plurality of integration clauses. Operation 114 may comprise testing the computer program according to the plurality of integration test cases.

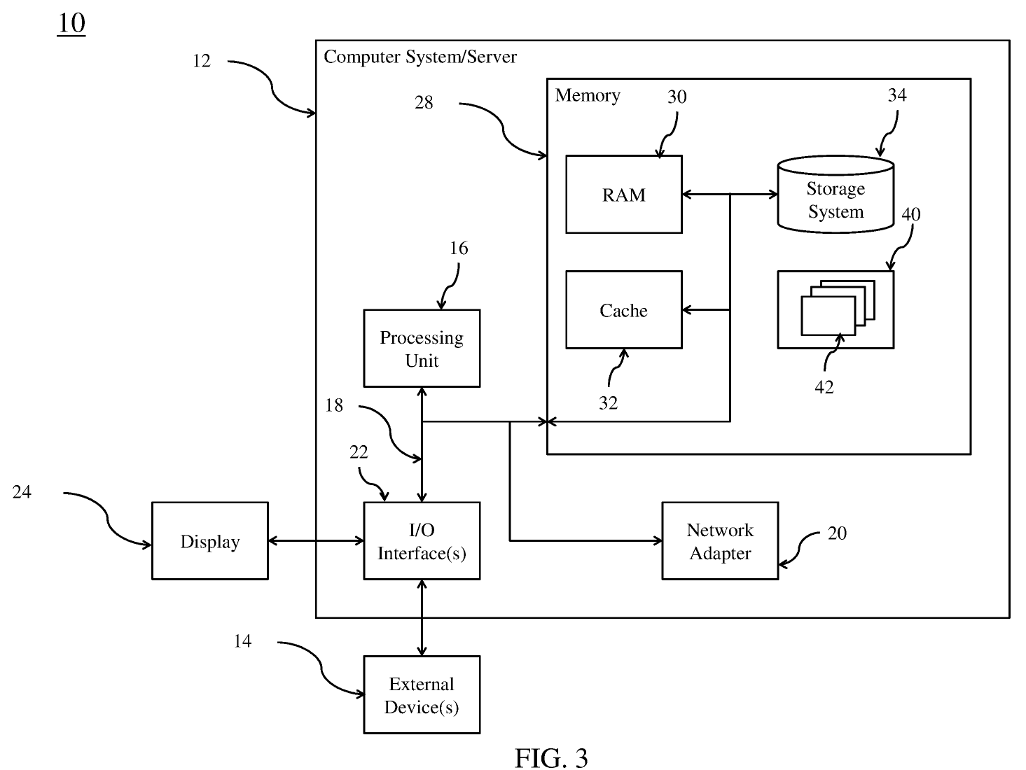

As shown in FIG. 3, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a "hard drive"). Although not shown, a magnetic disk drive for reading from and writing to a removable, non-volatile magnetic disk (e.g., a "floppy disk"), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various embodiments, a vector of features that includes the machine learning model input(s) may be provided to one or more of the machine learning models described herein. Based on the input features, one or more of the machine learning models described herein may generate one or more outputs. In some embodiments, the output(s) of the one or more machine learning models described herein may be a vector of features.

In various embodiments, the one or more machine learning models, described herein, may be pre-trained using training data. In various embodiments, training data may be retrospective data. In various embodiments, the retrospective data may be stored in a datastore. In various embodiments, the one or more machine learning models, described herein, may be additionally trained through manual curation of previously generated outputs.

In various embodiments, the one or more machine learning models, described herein, may be and/or may include a dynamic programming algorithm and/or model, such as a dynamic linear programming algorithm/model or a dynamic nonlinear programming algorithm/model. In various embodiments, the one or more machine learning models, described herein, may be a trained classifier. In various embodiments, the trained classifier may be a random decision forest. However, it will be appreciated that a variety of other classifiers are suitable for use according to the present disclosure, including linear classifiers, support vector machines (SVM), or artificial neural network models, such as generative adversarial networks (GANs) and/or recurrent neural networks (RNNs).

Suitable artificial neural network models include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the present invention is discussed primarily with respect to Unit and Integration testing, the systems, computer systems, computer program products, and methods described herein are applicable to all levels of software testing. The references to Unit and Integration tests are merely exemplary and should not be construed as limiting the scope of the invention. The comprehensive framework provided by this invention is designed to integrate and enhance the efficiency and effectiveness of testing across all phases, including but not limited to Functional, System, Acceptance, Regression, and Smoke testing.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of testing a computer program, the method comprising:
reading a first natural language description, the first natural language description describing a plurality of scenarios for testing a computer program;
identifying a plurality of unit clauses in the first natural language description, wherein each unit clause comprises a low-order verb;
generating a plurality of unit test cases such that a unit test case is generated for each of the plurality of unit clauses;
testing the computer program according to the plurality of unit test cases;
identifying a plurality of integration clauses in the first natural language description, wherein each integration clause is modified by at least one adverb;
generating a plurality of integration test cases such that an integration test case is generated for each of the plurality of integration clauses; and
testing the computer program according to the plurality of integration test cases.

2. The method of claim 1, wherein said testing of the computer program according to the plurality of unit test cases comprises:
selecting one or more input values from a dataset;
providing the one or more input values to the computer program in accordance with the plurality of unit test cases;
reading a first output generated by the computer program based on the input thereto; and
recording the first output and the one or more input values, and wherein
executing the plurality of integration test cases comprises:
providing the one or more input values as input to the computer program in accordance with the plurality of integration test cases; and
reading a second output generated by the computer program based on the input thereto.

3. The method of claim 2, the method further comprising:
providing first data as input to a generative machine learning model; and
reading simulated data from the generative machine learning model, and wherein
the dataset comprises the first data and the simulated data.

4. The method of claim 1, wherein each of the plurality of unit clauses lacks an adverb.

5. The method of claim 1, the method further comprising:
reading a second natural language description describing a set of requirements for the computer program; and
providing the second natural language description as input to a transformer network, and wherein
the first natural language description was generated by the transformer network based on the input thereto.

6. The method of claim 1, the method further comprising:
determining the computer program has been modified, and wherein
said testing of the computer program according to the plurality of integration tests is responsive to said determination.

7. The method of claim 1, the method further comprising:
identifying a first set of program branches covered by the plurality of unit test cases;
identifying a second set of paths covered by the plurality of integration test cases;
selecting the program branches in the first set and the second set; and
removing the selected program branches from the plurality of integration tests.

8. The method of claim 7, wherein each integration test case comprises at least one step, wherein each step is associated with at least one path covered by that integration test, wherein removing the selected program branches from the plurality of integration tests comprises:
removing, for each path of the selected program branches, each step associated with that path.

9. The method of claim 1, wherein identifying the plurality of unit clauses comprises:
organizing the first natural language description into one or more segments, wherein each segment comprises a verb and an adverb; and
identifying one or more low-order verbs in the one or more segments.

10. A computer program product comprising:
one or more computer-readable storage media; and
program instructions stored on the one or more computer-readable storage media to perform operations comprising:
reading a first natural language description, the first natural language description describing a plurality of scenarios for testing a computer program;
identifying a plurality of unit clauses in the first natural language description, wherein each unit clause comprises a low-order verb;
generating a plurality of unit test cases such that a unit test case is generated for each of the plurality of unit clauses;
testing the computer program according to the plurality of unit test cases;
identifying a plurality of integration clauses in the first natural language description, wherein each integration clause is modified by at least one adverb;
generating a plurality of integration test cases such that an integration test case is generated for each of the plurality of integration clauses; and
testing the computer program according to the plurality of integration test cases.

11. The computer program product of claim 10, wherein said testing of the computer program according to the plurality of unit test cases comprises:
selecting one or more input values from a dataset;
providing the one or more input values to the computer program in accordance with the plurality of unit test cases;
reading a first output generated by the computer program based on the input thereto; and
recording the first output and the one or more input values, and wherein
executing the plurality of integration test cases comprises:
providing the one or more input values as input to the computer program in accordance with the plurality of integration test cases; and
reading a second output generated by the computer program based on the input thereto.

12. The computer program product of claim 11, the operations further comprising:
providing first data as input to a generative machine learning model; and
reading simulated data from the generative machine learning model, and wherein
the dataset comprises the first data and the simulated data.

13. The computer program product of claim 10, the operations further comprising:
reading a second natural language description describing a set of requirements for the computer program; and
providing the second natural language description as input to a transformer network, and wherein
the first natural language description was generated by the transformer network based on the input thereto.

14. The computer program product of claim 10, the operations further comprising:
identifying a first set of program branches covered by the plurality of unit test cases;
identifying a second set of paths covered by the plurality of integration test cases;
selecting the program branches in the first set and the second set; and
removing the selected program branches from the plurality of integration tests.

15. The computer program product of claim 14, wherein each integration test case comprises at least one step, wherein each step is associated with at least one path covered by that integration test, wherein removing the selected program branches from the plurality of integration tests comprises:
removing, for each path of the selected program branches, each step associated with that path.

16. A computer system comprising:
a processor set;
one or more computer-readable storage media; and
program instructions stored on the one or more computer-readable storage media to perform operations comprising:
reading a first natural language description, the first natural language description describing a plurality of scenarios for testing a computer program;
identifying a plurality of unit clauses in the first natural language description, wherein each unit clause comprises a low-order verb;
generating a plurality of unit test cases such that a unit test case is generated for each of the plurality of unit clauses;
testing the computer program according to the plurality of unit test cases;
identifying a plurality of integration clauses in the first natural language description, wherein each integration clause is modified by at least one adverb;
generating a plurality of integration test cases such that an integration test case is generated for each of the plurality of integration clauses; and
testing the computer program according to the plurality of integration test cases.

17. The computer system of claim 16, wherein said testing of the computer program according to the plurality of unit test cases comprises:
selecting one or more input values from a dataset;
providing the one or more input values to the computer program in accordance with the plurality of unit test cases;
reading a first output generated by the computer program based on the input thereto; and
recording the first output and the one or more input values, and wherein
executing the plurality of integration test cases comprises:
providing the one or more input values as input to the computer program in accordance with the plurality of integration test cases; and
reading a second output generated by the computer program based on the input thereto.

18. The computer system of claim 17, the operations further comprising:
providing first data as input to a generative machine learning model; and
reading simulated data from the generative machine learning model, and wherein
the dataset comprises the first data and the simulated data.

19. The computer system of claim 16, the operations further comprising:
reading a second natural language description describing a set of requirements for the computer program; and
providing the second natural language description as input to a transformer network, and wherein
the first natural language description was generated by the transformer network based on the input thereto.

20. The computer system of claim 16, the operations further comprising:
identifying a first set of program branches covered by the plurality of unit test cases;
identifying a second set of paths covered by the plurality of integration test cases;
selecting the program branches in the first set and the second set; and
removing the selected program branches from the plurality of integration tests.
